(19) United States
(12) Patent Application Publication
(10) Pub. No.: US 2011/0137726 A1
(43) Pub. Date: Jun. 9, 2011

(54) RECOMMENDER SYSTEM BASED ON EXPERT OPINIONS

(75) Inventors: Xavier Amatriain, Madrid (ES); Josep M. Pujol, Madrid (ES); Neal Lathia, Madrid (ES); Pablo Rodriguez, Madrid (ES); Haewoon Kwak, Madrid (ES)

(73) Assignee: TELEFONICA, S.A., Madrid (ES)

(21) Appl. No.: 12/630,606

(22) Filed: Dec. 3, 2009

(51) Int. Cl. G06Q 30/00; G06N 5/04; G06N 5/02

(52) U.S. Cl. 705/14.52; 706/54; 706/52

(57) ABSTRACT

The invention refers to a method and system for recommending items of interest to a target and more particularly to a recommender system predicting user interest based on expert opinions.

### FIELD OF THE INVENTION

The present invention relates generally to computer systems for recommending items of interest, and more particularly to a recommender system predicting user interest based on expert opinions.

### BACKGROUND OF THE INVENTION

The goal of Recommender Systems (RS) is to model the user' tastes (preferences) in order to suggest or recommend unseen content that the users would find of interest.

Recommender systems have become an important research area because of the abundance of practical applications that help users to deal with information overload and provide personalized recommendations, content, and services to them. Examples of such applications include recommending books, CDs, and other products. Some of the vendors have incorporated recommendation capabilities into their commerce servers.

In its most common formulation, the recommendation problem is reduced to the problem of estimating ratings for the items that have not been seen by a user. Intuitively, this estimation is usually based on the ratings given by this user to other items and on some other information that will be formally described below. Once we can estimate ratings for the yet unrated items, we can recommend the item(s) with the highest estimated rating(s) to the user.

The recommendation problem can be formulated as follows: Let C be the set of all users and let S be the set of all possible items that can be recommended, such as books, movies, or restaurants. The space S of possible items can be very large, ranging in hundreds of thousands or even millions of items in some applications, such as recommending books or CDs. Similarly, the user space can also be very large-millions in some cases. Let u be a utility function that measures the usefulness of item to user c, i.e.:

u: C×S→R

where R is a totally ordered set (e.g., non negative integers or real numbers within a certain range). Then, for each user cεC, we want to choose such item s′εS that maximizes the users utility.

Each element of the user space C can be defined with a profile that includes various user characteristics, such as age, gender, income, marital status, etc. Similarly, each element of the item space S is defined with a set of characteristics. For example, in a movie recommendation application, where S is a collection of movies, each movie can be represented not only by its ID, but also by its title, genre, director, year of release, leading actors, etc.

The central problem of recommender systems lies in that utility u is usually not defined on the whole C×S space, but only on some subset of it. This means that u needs to be extrapolated to the whole space C×S. In recommender systems, utility is typically represented by ratings, which indicates how a particular user liked a particular item and is initially defined only on the items previously rated by the users.

Extrapolations from known to unknown ratings are usually done by specifying heuristics that define the utility function and empirically validating its performance and estimating the utility function that optimizes certain performance criterion, such as the mean square error.

Once the unknown ratings are estimated, actual recommendations of an item to a user are made by selecting the highest rating among all the estimated ratings for that user, according to [1].

Alternatively we can recommend the N best items to a user or a set of users to an item.

The new ratings of the not-yet-rated items can be estimated in many different ways using methods from machine learning, approximation theory, and various heuristics. Recommender systems are usually classified according to their approach to rating estimation into the following categories:

Content-based recommendations: The user will be recommended items similar to the ones the user preferred in the past. The utility u(c,s) of item s for user c is estimated based on the utilities u(c,sᵢ) assigned by user c to items sᵢεS that are “similar” to item s.

Collaborative recommendations (or collaborative filtering, CF): The user will be recommended items that people with similar tastes and preferences liked in the past. In this case, the recommender systems try to predict the utility of items for a particular user based on the items previously rated by other users. More formally, the utility u(c,s) of item s for user c is estimated based on the utilities u(cⱼ,s) assigned to item by those users cⱼεC who are “similar” to user c.

One of commonly used technique for collaborative filtering is Nearest Neighbour algorithm (k-NN): is a method for classifying objects based on closest training examples in the feature space where the function is only approximated locally and all computation is deferred until classification. k-NN is based on cosine and correlation functions.

Hybrid approaches: These methods combine collaborative and content-based methods.

Collaborative filtering is the current mainstream approach used to build web-based recommender systems. CF algorithms assume that in order to recommend items to users, information can be drawn using only what users liked in the past and not any additional information about the users or items. In user-based CF algorithms recommendations are computed by computing similar users and recommending what these users liked in the past. On the other hand, item-based CF algorithms computed similar items to the ones the user liked in the past. For computing these similar items, the only information used is how much other users liked them.

As shown in “Collaborative filtering using dual information sources” (CHO J. et al, IEEE Intelligent Systems, 22(3):30-38, 2007), the use of experts, instead of the whole available group of users, to generate predictions in a recommender system has been explored. The approach is focused on identifying expert users from a closed community of users, by deriving a “domain authority” reputation-like score for each user in the data set.

The idea of expertise is also related to that of trust. In trust-aware recommender systems the influence of neighbors is weighed by a measure of how trustworthy they are for the current user. The trust measure can be defined and obtained in different ways, for instance, a measure of trust is computed by looking at how well a neighbor has predicted past ratings.

One option to obtain a set of ratings from a reduced population of experts in a given domain is to obtain item evaluations from trusted sources and use a rating inference model (as in “Modeling online reviews with multi-grain topic models”, TITOV I. et al, In Proc. of WWW '08, 2008), or an automatic expert detection model (“Broad expertise retrieval in sparse data environments”, BALOG K. et al, In Proc. of SIGIR '07, 2007). In domains where there are online expert evaluations (e.g. movies, books, cars, etc.) that include a quantitative rating, it is feasible to crawl the web in order to gather expert ratings.

Alternative approaches to populate a database of expert ratings include—but are not limited to—a manually-maintained database of dedicated experts, or the compilation of expert opinions collected by crawling and inferring quantitative ratings from online reviews.

The main problems with existing solutions are the following ones:

Data sparsity: In a standard collaborative recommender system, the user-rating data is very sparse. Although dimensionality techniques of reduction offer some help, this problem is still a source of inconsistency and noise in the predictions.

Noise and malicious ratings: Users introduce noise when giving their feedback to a recommender system, both in the form of careless ratings and malicious entries, which will affect the quality of predictions. It has been found that a significant part of the error in explicit feedback-based CF algorithms is due to the noise in the users' explicit feedback.

Cold start problem: In a CF system, new items lack rating data and cannot be recommended; the same is true when a new user enters the system.

Scalability: Computing the similarity matrix for N users in an M-item collection is an O(N²M) problem. This matrix needs to be updated on a regular basis, as new items and/or users enter the system. Therefore, CF based approaches typically suffer from scalability limitations. While there are several ways to address this issue—such as k-means clustering (“Scalable collaborative filtering using cluster-based smoothing”, XUE G. et al, In Proc. of SIGIR '05, 2005), scalability is still an open research problem in CF systems.

Privacy: Privacy in CF recommender systems is a growing concern and still an area of research. In order to maintain and update the similarity matrix, the system has to transmit all user ratings to a central node where the matrix is computed.

k-NN: The Nearest Neighbor algorithm, for each user, tries to find a number of similar users whose profiles can then be used to predict recommendations. However, defining similarity between users is not an easy task: basically it is limited by the sparsity and noise in the data and is computationally expensive.

### SUMMARY OF THE INVENTION

The invention refers to a method for recommending one or more available items to a target user u according to claim 1. Preferred embodiments of the method are defined in the dependent claims.

In order to overcome the problems of the existent recommender systems, the present invention provides a method for recommending an item which is a variation of traditional collaborative filtering: rather than applying a nearest neighbor algorithm to the user-rating data, predictions are computed using a set of expert neighbors from an independent dataset, whose opinions are weighted according to their similarity to the user.

An expert (professional raters in a given domain) is defined as an individual that can be trusted to have produced thoughtful, consistent and reliable evaluations (ratings) of items in a given domain.

The invention refers to a method for recommending one or more available items to a target user u, comprising the steps of:

obtaining a set of ratings for a plurality of available items from a group of expert users E={e₁, . . . , eₖ};

computing a similarity measure between a target user u and an expert e according to the following equation:

$$sim ( u , e ) = \frac{{\sum }^{i} ( {r}_{ui} {r}_{ei} )}{\sqrt{{\sum }^{i} {r}_{ui}^{2}} \sqrt{{\sum }^{i} {r}_{ei}^{2}}} \cdot \frac{2 {N}_{u ⋃ e}}{{N}_{u} + {N}_{e}} \qquad [ 2 ]$$

where rᵤᵢ and rₑᵢ are the target user and expert ratings for item i, respectively, Nᵤ and Nₑ are the number of items rated by the target user and the expert, respectively, and N_{u∪e} is the number of co-rated items;

determining a set E′ of the group of experts E, E′ [symbol] E, whose similarity to the target user is greater than a pre-established threshold δ;

computing a predicted rating for an item j by means of a similarity-weighted average of the ratings input from each expert e in E′:

$${r}_{uj} = {σ}_{u} + \frac{{\sum }_{e ⊆ {E}^{′}} ( {r}_{ej} - {σ}_{e} ) \cdot sim ( u , e )}{\sum sim ( u , e )} \qquad [ 3 ]$$

where rᵤⱼ is the predicted rating of item j for user u, rₑⱼ is the known rating for expert e of item j, and σᵤ and σₑ are the respective mean ratings; and

recommending that item j to the target user u if said predicted rating rᵤⱼ is above a pre-established value.

In order to avoid the drawback of using a fixed-threshold δ which has the risk of finding very few neighbors, the invention further comprises:

defining a confidence threshold τ as the minimum number of experts who must have rated item i in order to trust their prediction;

determining a subset E″={e₁, . . . , eₙ} of the set of experts E′, E″ [symbol] E′, which includes the experts who have rated item j; and,
if the number n of experts in the subset E″ is equal or above said confidence threshold τ, the predicted rating rᵤⱼ computed according to equation [3] is returned;
if the number n of experts in the subset E″ is less than said confidence threshold τ, no prediction can be made and the mean rating σᵤ for that user is returned.

The step of obtaining a set of ratings from a population of experts in a given domain can be obtained in several possible ways, such as:
item evaluations from trusted sources and use a rating inference model;
using an automatic expert detection model;
maintaining a database of dedicated experts.

The goal when using external data sources is not as much on prediction accuracy as it is on addressing some of the common problems found in traditional CF recommender systems described previously.

Data sparsity: this issue is addressed since domain experts are more likely to have rated a large percentage of the items.

Noise and malicious ratings: Experts are expected to be more consistent and conscious with their ratings, thus reducing noise. In addition, an expert data set can be immune to malicious, profile-injection attacks as it is an easy to control and stable data set.

Cold start problem: Motivated expert users typically rate a new item entering the collection as soon as they know of its existence and therefore minimize item cold-start.

Scalability: the recommender system of the present invention is less sensitive to scale, as it creates recommendations from a much reduced set of experts.

Privacy: The present invention does not need to keep a centralized matrix will all user data, since the similarity matrix only includes expert data and the target user. In expert-CF, the current expert ratings can be easily transmitted thanks to the reduced size of the matrix, such that all computation is performed locally on the client. This advantage is particularly relevant in a mobile scenario.

Thus, the present invention uses a set of expert ratings to generate predictions for a large population of users, such as, for example, using online reviews from critics. Therefore, the present invention uses feedback from less noisy sources (i.e. experts) to build recommendations.

### DETAILED DESCRIPTION OF THE PREFERRED EMBODIMENTS

Reference will now be made in detail to a preferred embodiment of the recommender system of the present invention, in which professional raters in a given domain (i.e. experts) can predict the behavior of the general population. The expert is defined as an individual that can be trusted to have produced thoughtful, consistent and reliable evaluations (ratings) of items in a given domain.

The proposed invention consists of a recommender system that uses a set of expert ratings to generate predictions for a large population of users, such as, for example, using online reviews from critics. This way, recommendations are built using feedback from less noisy sources, i.e., the experts.

The present example is based on using online reviews from movie critics. However, it is also possible to think of a small set of “professional” raters maintaining a rating database. This is reminiscent but less demanding than content-based recommender systems that rely on experts to manually categorize and label content.

The first step in the invention requires obtaining a set of ratings from a reduced population of experts in a given domain. This collection of expert's ratings can be obtained according to known methods such as:
obtaining item evaluations from trusted sources and either use ratings directly if available or a rating inference model (“Modeling online reviews with multi-grain topic models”, TITOV I. et al, In Proc. of WWW '08, 2008), or
an automatic expert detection model (“Broad expertise retrieval in sparse data environments”, BALOG K. et al, In Proc. of SIGIR '07, 2007), or
manually-maintaining a database of dedicated experts.

The present invention does not require a particular way of extracting the expert ratings. However, it does require that these expert ratings are obtained from a source that is external to the user database that will be targeted for the predictions. The reason is that we need to guarantee there is limited noise in the ratings and we cannot guarantee this on a general user database.

The key of the invention is on using such an external and reduced source of ratings to predict the general population.

For example, in a possible implementation of the present invention, the Rotten Tomatoes (http://www.rottentomatoes.com) web site—which aggregates the opinions of movie critics from various media sources—has been crawled to obtain expert ratings of the movies in the Netflix (http://www.netflix.com) data set.

In a first stage, a matrix of expert-item ratings is populated. Then, the similarity between all pairs of users is computed, based on a pre-determined measure of similarity. A variation of the cosine similarity is used which includes an adjusting factor to take into account the number of items co-rated by both users.

So given a target user u and an expert user e, the similarity between the target user u and an expert user e, sim (u,e) is computed as:

$$sim ( u , e ) = \frac{{\sum }^{i} ( {r}_{ui} {r}_{ei} )}{\sqrt{{\sum }^{i} {r}_{ui}^{2}} \sqrt{{\sum }^{i} {r}_{ei}^{2}}} \cdot \frac{2 {N}_{u ⋃ e}}{{N}_{u} + {N}_{e}} \qquad [ 2 ]$$

where rᵤᵢ and rₑᵢ are the target user and expert ratings for item i, Nᵤ and Nₑ are the number of items rated by the target user and the expert, respectively, and N_{u∪e} is the number of co-rated items.

The present invention uses an approach to collaborative filtering that only uses expert opinions to predict user ratings. Therefore, this invention does not require the user-user similarity to be computed; instead, a similarity matrix between each user and the expert set is built.

In order to predict a user's rating for a particular item, we look for experts whose similarity to the target user is greater than a pre-established threshold δ. Formally: given a space V of users and experts and a similarity measure sim: V×V→R, a group of experts E={e₁, . . . , eₖ} [symbol] V and a set of users U={u₁, . . . , u_{N}} [symbol] V are defined. Given a particular user u [symbol] U and a pre-established threshold δ, a set of experts E′ [symbol] E is found such that: ∀e [symbol] E′ [symbol] sim(u,e)≧δ, where the similarity measure sim is obtained according to equation [2] above.

One of the drawbacks of using a fixed threshold δ is the risk of finding very few neighbors; furthermore, the ones that are found may not have rated the current item. In order to deal with this problem, a confidence threshold τ may be defined as the minimum number of expert neighbors who must have rated the item in order to trust their prediction. Given the set of experts E′ found in the previous step and an item j, the subset E″ [symbol] E′ such that ∀e [symbol] E″ [symbol] rₑⱼ≠0, where rₑⱼ is the rating of item j by expert e [symbol] E′, and 0 is the value of the unrated item.

Once this subset of experts E″=e₁, . . . , eₙ has been identified, if n<τ, no prediction can be made and the user mean is returned. On the other hand, if n≧τ, a predicted rating can be computed. This is done by means of a similarity-weighted average of the ratings input from each expert e in E″:

$${r}_{uj} = {σ}_{u} + \frac{{\sum }_{e ⊆ {E}^{′}} ( {r}_{ej} - {σ}_{e} ) \cdot sim ( u , e )}{\sum sim ( u , e )} \qquad [ 3 ]$$

where rᵤⱼ is the predicted rating of item j for user u, rₑⱼ is the known rating for expert e to item j, and σᵤ and σₑ are the respective mean ratings.

The optimal setting of these parameters δ and τ depends on the data set and the application in mind.

As indicated before, the present invention relates to a recommender system. It is to be understood that the above disclosure is an exemplification of the principles of the invention and does not limit the invention to the described embodiments.

1. A method for recommending one or more available items to a target user u, comprising the steps of:
obtaining a set of ratings for a plurality of available items from a group of expert users E={e₁, . . . , eₖ};
computing, using a computer system, a similarity measure between a target user u and an expert e according to the following equation:
$$sim ( u , e ) = \frac{{\sum }^{i} ( {r}_{ui} {r}_{ei} )}{\sqrt{{\sum }^{i} {r}_{ui}^{2}} \sqrt{{\sum }^{i} {r}_{ei}^{2}}} \cdot \frac{2 {N}_{u ⋃ e}}{{N}_{u} + {N}_{e}} \qquad [ 2 ]$$
where rᵤᵢ and rₑᵢ are the target user and expert ratings for an item i, respectively, Nᵤ and Nₑ are the number of items rated by the target user and the expert, respectively, and N_{u∪e} is the number of co-rated items;
determining a set E′ of the group of experts E, E′ [symbol] E, whose similarity to the target user is greater than a pre-established threshold δ;
computing, using a computer system, a predicted rating for an item i by means of a similarity-weighted average of the ratings input from each expert e in E′:
$${r}_{uj} = {σ}_{u} + \frac{{\sum }_{e ⊆ {E}^{′}} ( {r}_{ej} - {σ}_{e} ) \cdot sim ( u , e )}{\sum sim ( u , e )} \qquad [ 3 ]$$
where rᵤⱼ is a predicted rating of item j for user u, rₑⱼ is the known rating for expert e of item j, and σᵤ and σₑ are the respective mean ratings; and
selecting an item j for recommendation to the target user u if said predicted rating rᵤᵢ is above a pre-established value.

2. Method according to claim 1, which further comprises:
defining a confidence threshold τ as the minimum number of experts who must have rated item i in order to trust their prediction;
determining a subset E″={e₁, . . . , eₙ} of the set of experts E′, E″ [symbol] E′, which includes the experts who have rated item i; and,
if the number n of experts in the subset E″ is equal or above said confidence threshold τ, the predicted rating rᵤᵢ computed according to equation [3] is returned;
if the number n of experts in the subset E″ is less than said confidence threshold τ, no prediction can be made and the mean rating σᵤ for that user is returned.

3. Method according to any of claims 1-2, wherein the set of ratings for a plurality available items is obtained from item evaluations from trusted sources and use a rating inference model.

4. Method according to any of claims 1-2, wherein the set of ratings for a plurality available items is obtained using an automatic expert detection model.

5. Method according to any of claims 1-2, wherein the set of ratings for a plurality available items is obtained manually, maintaining a database of dedicated experts.
